(19) United States
(12) Patent Application Publication
(10) Pub. No.: US 2010/0215009 A1
(43) Pub. Date: Aug. 26, 2010

(54) METHOD AND APPARATUS FOR RESOURCE ALLOCATION IN A MULTI HOP RELAY NETWORK

(75) Inventors: Tak Ki YU, Yongin-si (KR); Young Bin Chang, Anyang-si (KR); Seung Hee Han, Hwaseong-si (KR); San Min Lee, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/709,173

(22) Filed: Feb. 19, 2010

(30) Foreign Application Priority Data
Feb. 20, 2009 (KR) 10-2009-0014227

(51) Int. Cl. H04W 72/04

(52) U.S. Cl. 370/329

(57) ABSTRACT

A method of resource allocation by a base station in a multi hop relay network includes identifying a number of relays participating in a cooperative communication; dividing a sub-frame resource interval of the relay according to the identified number of relays in a time domain; and allocating resources so that only two relays can communicate with each other in a divided resource zone, and transmitting data while performing multi-hopping between the relays, wherein only the two relays communicate with each other during the hopping.

### PRIORITY

This application claims priority to Korean Patent Application No. 10-2009-0014227 filed in the Korean Intellectual Property Office on Feb. 20, 2009, the entire contents of which are hereby incorporated by reference.

### BACKGROUND OF THE INVENTION

1. Field of the Invention

The present invention relates to a method and an apparatus for resource allocation by a base station in a multi hop relay network. More particularly, the present invention relates to a method and an apparatus for resource allocation, so that the method and apparatus of the present invention can prevent interference that may occur during communication between relays.

2. Description of the Related Art

The next generation mobile communication system is expected to increasingly depend on relay stations for communication, rather than using a base station controlling all the communication in an entire coverage area. By installing relays, it is possible to not only extend the coverage area but also increase the capacity. Differently from the analog repeater or the digital repeater used in the conventional cellular system, a relay system can perform radio resource management in consideration of interference and resource status. Therefore, the multi hop relay system can secure a level of quality, can increase the capacity, and can provide a service to even a mobile station located in a shade area, thereby increasing the coverage area.

The Institute of Electrical and Electronic Engineers (IEEE) 802.16j/m standard requires support of multi hops including at least three hops. Therefore, the IEEE 802.16j standard group is now discussing a protocol for discriminating between relays corresponding to even hops and relays corresponding to odd hops and alternately transmitting data to the relays corresponding to even hops, and the relays corresponding to odd hops, and the IEEE 802.16m standard group is also discussing a similar multi hop relay protocol.

As described above, there a need for a scheme for enabling communication without interference between a higher relay and a lower relay in a multi hop relay network supporting multi hops including at least three hops, and it is necessary to propose a specific resource allocation scheme in the IEEE 802.16m standard.

### SUMMARY OF THE INVENTION

The present invention has been made in view of at least the above problems, and provides a method of radio resource management for preventing interference between a higher relay and a lower relay in a multi hop relay network.

The present invention provides a method of radio resource management for preventing interference between a higher relay and a lower relay in a multi hop relay network including at least three hops.

In accordance with an aspect of the present invention, a method of resource allocation by a base station in a multi hop relay network includes identifying a number of relays participating in a cooperative communication; dividing a sub-frame resource interval of the relay according to the identified number of relays in a time domain; and allocating resources so that only two relays can communicate with each other in a divided resource zone, and transmitting data while performing multi-hopping between the relays, wherein only the two relays communicate with each other during the hopping.

In accordance with another aspect of the present invention, a method of resource allocation by a base station in a multi hop relay network transmitting and receiving a sub-frame including a first zone and a second zone includes identifying a number of relays participating in a cooperative communication; grouping multiple consecutive sub-frames according to the identified number of relays; and allocating resources so that only two relays can communicate with each other in the first zone and the second zone of the grouped multiple sub-frames, and transmitting data while performing multi-hopping between the relays, wherein only the two relays communicate with each other during the hopping.

In accordance with another aspect of the present invention, an apparatus for resource allocation in a multi hop relay network includes a relay grouping unit for identifying a number of relays participating in a cooperative communication and grouping the relays; and a resource allocation unit for dividing a sub-frame resource interval of the relay according to the number of grouped relays in a time domain and allocating resources so that only two relays can communicate with each other in a divided resource zone.

In accordance with another aspect of the present invention, an apparatus for resource allocation in a multi hop relay network transmitting and receiving a sub-frame including a first zone and a second zone includes a relay grouping unit for identifying a number of relays participating in a cooperative communication and grouping the relays; and a resource allocation unit for grouping multiple consecutive sub-frames according to the identified number of relays and allocating resources so that only two relays can communicate with each other in the first zone and the second zone of the grouped multiple sub-frames.

### BRIEF DESCRIPTION OF THE DRAWINGS

The objects, features and advantages of the present invention will be more apparent from the following detailed description in conjunction with the accompanying drawings, in which: FIG. 1a illustrates a conventional multi hop relay network in which interference occurs between adjacent relays;

FIG. 1b illustrates resource allocation structures of a downlink sub-frame and an uplink sub-frame defined in the current IEEE 802.16m standard;

FIG. 2 is a block diagram illustrating an internal structure of a base station, which is commonly applicable to a first embodiment and a second embodiment of the present invention;

FIG. 3a illustrates an in-frame resource allocation method of a downlink sub-frame when three relays are participating in a cooperative communication;

FIG. 3b illustrates the method of communication between nodes based on the resources allocated according to the method of FIG. 3a;

FIG. 4a illustrates a resource allocation method of a downlink sub-frame when four relays are participating in a cooperative communication;

FIG. 4b illustrates the method of communication between nodes based on the resources allocated according to the method of FIG. 4a;

FIG. 5 is a flow diagram illustrating an operation process of a base station according to the first embodiment of the present invention;

FIG. 6A illustrates a multi-frame resource allocation method of downlink sub-frames when three relays are participating in a cooperative communication;

FIG. 6b illustrates the method of communication between nodes based on the resources allocated according to the method of FIG. 6A;

FIG. 7a illustrates a multi-frame resource allocation method of downlink sub-frames when four relays are participating in a cooperative communication;

FIG. 7b illustrates the method of communication between nodes based on the resources allocated according to the method of FIG. 7a;

FIG. 8 is a flow diagram illustrating an operation process of a base station according to the second embodiment of the present invention; and

FIG. 9 is a flow diagram illustrating a process of initial network entry of a relay for a radio resource management operation according to an embodiment of the present invention.

### DETAILED DESCRIPTION OF EXEMPLARY EMBODIMENTS

Hereinafter, embodiments of the present invention are described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention.

While the terms used herein follow the IEEE 802.16j/m standard, they are not intended to limit the scope or understanding of the invention.

The following description includes specific embodiments of a resource allocation method in a multi hop relay network, which are divided into a first embodiment and a second embodiment. The first embodiment relates to an in-frame resource allocation method in which a base station divides a single sub-frame resource interval according to the number of relays and allocates the divided resource. The second embodiment relates to a multi frame resource allocation method in which a base station groups sub-frames according to the number of relays and then allocates resources to each relay.

Although the following description discusses a resource allocation method in a downlink sub-frame, the same principle can be applied to a resource allocation method in an uplink sub-frame.

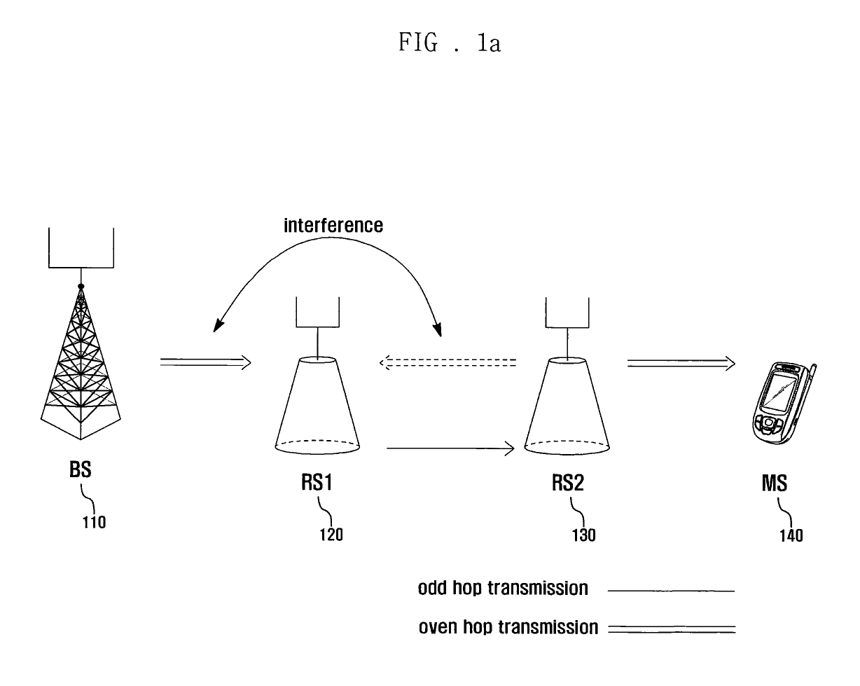

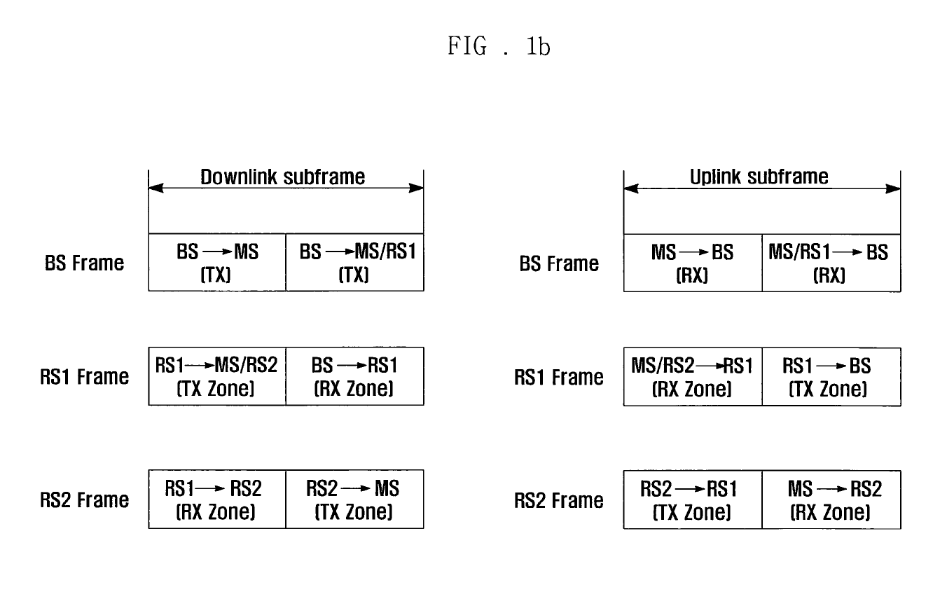

FIG. 1a shows a conventional multi hop relay network in which interference occurs between adjacent relays.

The IEEE 802.16j standard presents a method of discriminating between relays corresponding to even hops and relays corresponding to odd hops and alternately transmitting data to the relays corresponding to even hops and the relays corresponding to odd hops. From among the relays shown in FIG. 1a, a first relay (RS1) 120 is a relay corresponding to an odd hop, and a second relay (RS2) 130 is a relay corresponding to an even hop.

The data transmitted by the second relay 130 should be received by only mobile station 140 that corresponds to a lower node. If the data is received by a node other than the lower node, the data is considered and treated as a noise, which causes interference.

Referring to FIG. 1a, in a transmission zone in which the second relay 130 transmits data, the first relay 120 operates in a reception mode in order to receive the data transmitted from a base station 110. The data transmitted by the second relay station 130 is delivered to not only the mobile station 140 but also the first relay station 120. The first relay station 120, which should receive only the data transmitted from the base station 110, deals with the data transmitted from the second relay station 130 as noise, which causes interference.

Therefore, it is necessary to arrange a radio resource management method for controlling interference between a higher relay and a lower relay in a multi hop relay network, especially in a three or more hop relay network.

In order to solve the problems mentioned above, the present invention defines a silent zone in which a relay does not transmit any signal at all, within a particular zone of an uplink or a downlink sub-frame. Further, a base station according to the present invention allocates the silent zone as a zone in which only two relays can communicate with each other in the same time zone of a sub-frame. A more detailed description on the resource allocation using the silent zone according to the present invention will be given through the first embodiment and the second embodiment described below.

FIG. 1b illustrates resource allocation structures of a downlink sub-frame and an uplink sub-frame defined in the current IEEE 802.16m standard.

As shown in FIG. 1b, in the IEEE 802.16m standard, a downlink sub-frame or an uplink sub-frame is divided into two zones, to which resources are allocated so that a base station or a relay can operate in a reception mode or a transmission mode. A more detailed description will be given hereinafter with reference to the downlink sub-frame shown in FIG. 1b.

A base station frame is divided into two transmission zones, wherein the base station transmits a signal to the mobile station in the first transmission zone and the base station transmits a signal to the mobile station and the first relay in the second transmission zone.

Each of a first relay frame and a second relay frame is divided into one transmission zone and one reception zone. The reception zone of the first relay frame corresponds to the second transmission zone (that is, a zone for transmitting a signal to the first relay) of the base station frame. The transmission zone of the first relay frame corresponds to the reception zone of the second relay frame. The transmission zone of the second relay frame corresponds to the reception zone of the first relay frame.

The above description can also be applied to the uplink sub-frame, so a detailed description on the structure of the uplink sub-frame is omitted.

The first embodiment of the present invention employs a modification of the sub-frame structure shown in FIG. 1b. Although one sub-frame is divided into two resource zones in the conventional standard, a base station divides one sub-frame resource interval according to the number of relays participating in a cooperative communication.

The second embodiment of the present invention employs the sub-frame structure shown in FIG. 1b without change, and a base station according to the second embodiment of the present invention allocates resources after grouping sub-frames according to the number of relays participating in a cooperative communication.

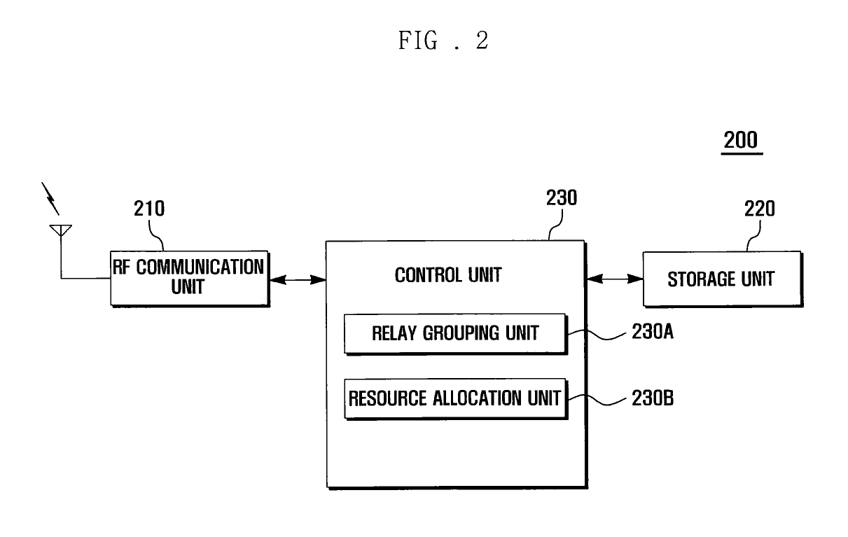

FIG. 2 is a block diagram illustrating an internal structure of a base station 200, which is commonly applicable to the first embodiment and the second embodiment of the present invention. The base station 200 of the present invention includes an RF communication unit 210, a storage unit 220, and a control unit 230. The control unit 230 includes a relay grouping unit 230A and a resource allocation unit 230B.

The RF communication unit 210 includes an RF transceiver and a duplexer, and performs functions of a typical base station including RF transmission/reception.

The storage unit 220 may store programs and data necessary for general operations of a base station according to an embodiment of the present invention.

The storage unit 220 may store programs for the execution of a multi frame resource allocation method or an in-frame resource allocation method according to an embodiment of the present invention.

The control unit 230 controls the general operation of the base station according to an embodiment of the present invention. The control unit 230 according to an embodiment of the present invention may include the relay grouping unit 230A and the resource allocation unit 230B.

The relay grouping unit 230A identifies the number of relays participating in a cooperative communication and groups relays, to which it will apply the multi frame resource allocation method or the in-frame resource allocation method according to the present invention. The relay grouping unit 230A outputs the number of the relays participating in the cooperative communication.

The resource allocation unit 230B receives the number of the relays participating in the cooperative communication from the relay grouping unit 230A. Then, the resource allocation unit 230B allocates resources after dividing one sub-frame resource interval according to the number of relays based on the time unit (the first embodiment) or grouping multiple sub-frames according to the number of relays (the second embodiment).

In the in-frame resource allocation method according to the first embodiment of the present invention, the resource allocation unit 230B divides one sub-frame into multiple zones according to the number of relays based on the time unit. The resource allocation unit 230B allocates resources to only two relays for communication with each other in each divided zone, and allocates a silent zone to the other relays except for the two relays communicating with each other.

In the multi frame resource allocation method according to the second embodiment of the present invention, the resource allocation unit 230B groups multiple consecutive sub-frames corresponding to the number of relays. The resource allocation unit 230B divides each of the grouped sub-frames into a first zone and a second zone and allocates resources to each of the divided zones such that only two relays can communicate with each other, while allocating a silent zone to the other relay or relays.

### 1^{st} Embodiment

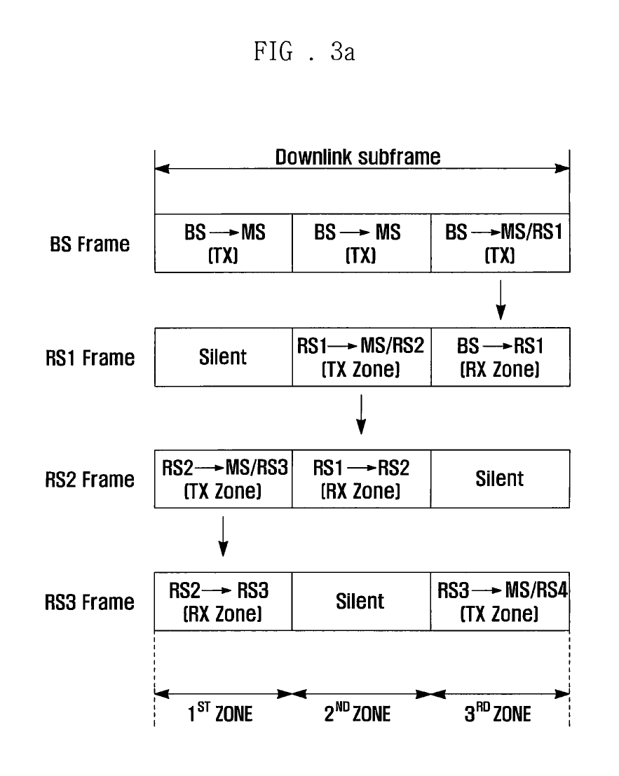

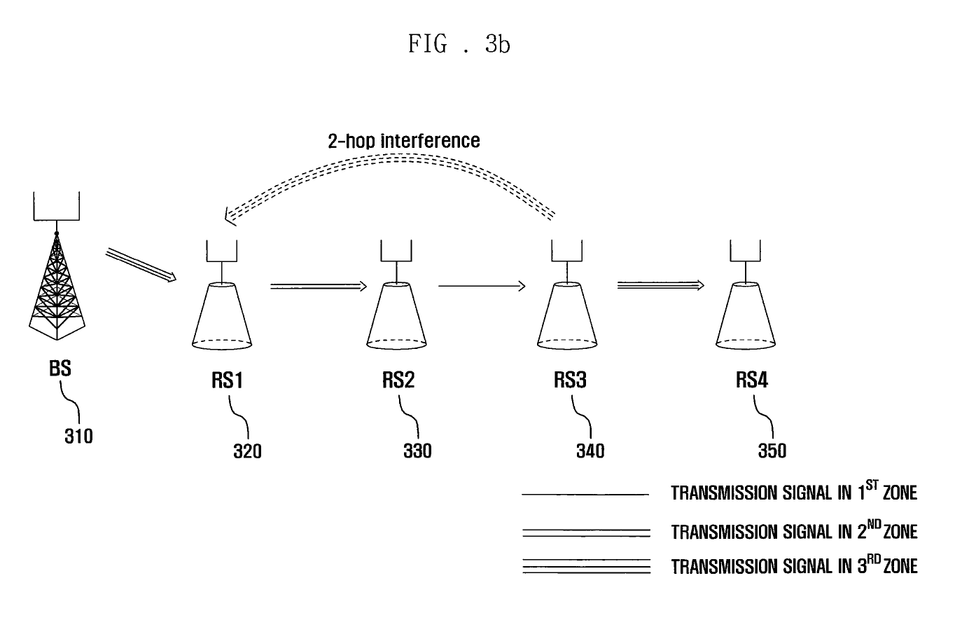

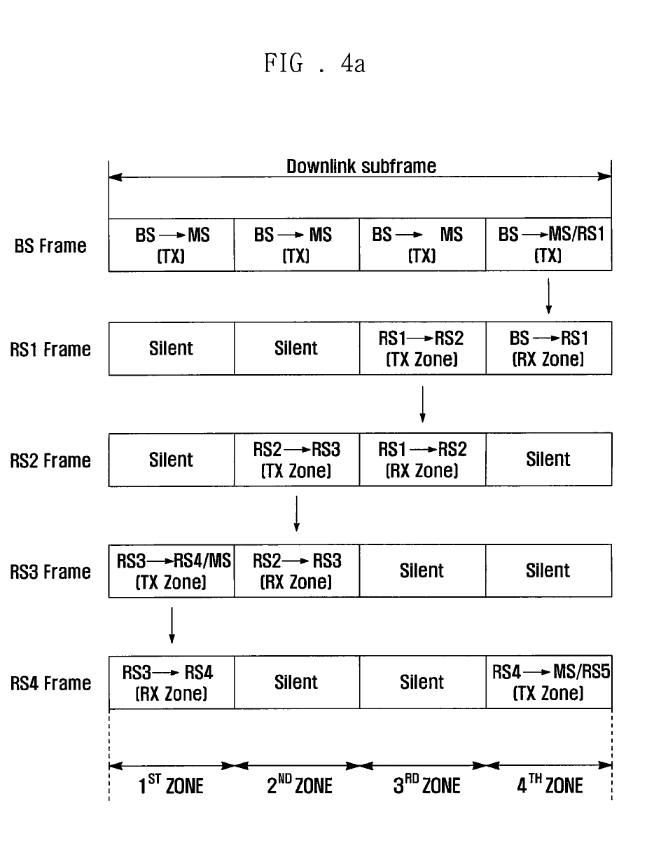

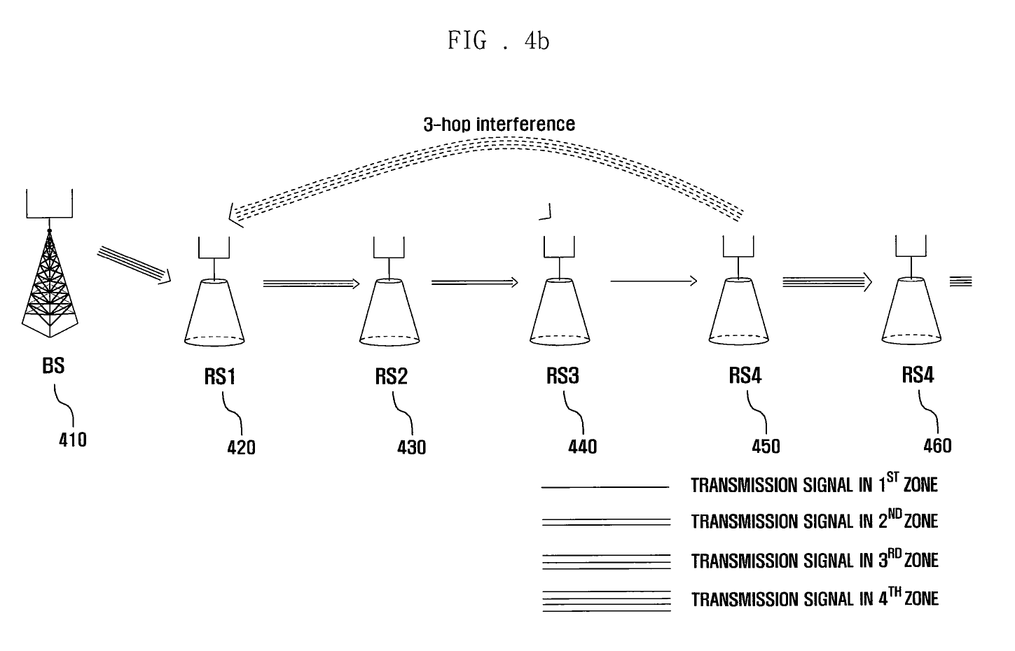

An in-frame resource allocation method in which a base station divides a resource interval according to the number of relays in a time domain and then allocates resources will be described. FIGS. 3a and 3b correspond to a case in which three relays are participating in a cooperative communication, and FIGS. 4a and 4b correspond to a case in which four relays are participating in a cooperative communication.

FIG. 3a illustrates an in-frame resource allocation method of a downlink sub-frame when three relays are participating in a cooperative communication.

Further, FIG. 3b illustrates the method of communication between nodes based on the resources allocated according to the method of FIG. 3a.

Referring to FIG. 3a, a base station identifies the number of relays participating in a cooperative communication and divides the resource interval of the sub-frame according to the number of relays in a time domain. In FIG. 3a, since the number of relays participating in a cooperative communication is three, the base station divides the resource interval of the sub-frame into a first zone, a second zone, and a third zone.

The base station allocates resources such that only two relays can communicate with each other in each zone. In the first zone, the base station allocates the second relay frame to a transmission zone and the third relay frame to a reception zone so that the second relay and the third relay can communicate with each other. The base station allocates the first relay frame to a silent zone, in order to prevent interference to the communication between the second relay and the third relay.

In the second zone, the base station allocates the first relay frame to a transmission zone and the second relay frame to a reception zone so that the first relay and the second relay can communicate with each other. The base station allocates the third relay frame to a silent zone, in order to prevent interference to the communication between the first relay and the second relay.

In addition, in the third zone, the base station allocates the first relay frame to a reception zone and the third relay frame to a transmission zone so that the base station and the first relay can communicate with each other and the third relay and a fourth relay (or a mobile station) can communicate with each other. Further, the base station allocates the second relay frame to a silent zone, in order to prevent occurrence of interference to the communication described above.

According to the present embodiment, in the same resource zone, the base station can allocate a resource for a lower relay of a relay having a resource, which has been allocated to a reception zone, to a silent zone. For example, in the third zone, since the base station allocates the first relay frame to the reception zone, the base station can allocate the resource for the second relay, which is a lower relay of the first relay, to the silent zone. The same can be applied to the other zones.

FIG. 3b illustrates the method of communication between nodes according to the resource allocation method as described above. In each resource zone of the first to third zones of the sub-frame of the present invention, only two adjacent nodes communicate with each other. Therefore, it is possible to minimize the interference that may occur between the relays.

In the conventional multi hop relay network as shown in FIGS. 1a and 1b, each relay may undergo interference (1-hop interference) due to an adjacent relay. However, according to an embodiment of the present invention as shown in FIG. 3b, the distance of interference becomes greater (2-hop interference), which can reduce the intensity of interference having an influence on the relay.

FIG. 4a illustrates a resource allocation method of a downlink sub-frame when four relays are participating in a cooperative communication. Further, FIG. 4b illustrates the method of communication between nodes based on the resources allocated according to the method of FIG. 4a.

Referring to FIG. 4a, since the number of relays participating in a cooperative communication is four, the base station divides the resource interval of the sub-frame into a first zone, a second zone, a third zone and a fourth zone.

The base station allocates resources such that only two relays can communicate with each other in each zone. In the first zone, the base station allocates the third relay frame to a transmission zone and the fourth relay frame to a reception zone so that the third relay and the fourth relay can communicate with each other. The base station allocates the first relay frame and the second relay frame to silent zones, in order to prevent interference to the communication between the third relay and the fourth relay.

In the second zone, the base station allocates the second relay frame to a transmission zone and the third relay frame to a reception zone so that the second relay and the third relay can communicate with each other. The base station allocates the first relay frame and the fourth relay frame to silent zones, in order to prevent interference to the communication between the second relay and the third relay.

In the third zone, the base station allocates the first relay frame to a transmission zone and the second relay frame to a reception zone so that the first relay and the second relay can communicate with each other. The base station allocates the third relay frame and the fourth relay frame to silent zones, in order to prevent interference to the communication between the first relay and the second relay.

In the fourth zone, the base station allocates the first relay frame to a reception zone and the fourth relay frame to a transmission zone so that the base station and the first relay can communicate with each other and the fourth relay and a fifth relay (or a mobile station) can communicate with each other. the base station allocates the second relay frame and the third relay frame to silent zones, in order to prevent interference to the communication described above.

According to the present embodiment, in the same resource zone, the base station can allocate a resource for a lower relay of a relay having a resource, which has been allocated to a reception zone, to a silent zone. For example, in the third zone, since the base station allocates the second relay frame to the reception zone, the base station can allocate the resources for the third relay and the fourth relay, which are lower relays of the second relay, to the silent zones. The same can be applied to the other zones.

FIG. 4b illustrates the method of communication between nodes according to the resource allocation method as described above. According to an embodiment of the present invention as shown in FIG. 4b, the distance of interference becomes greater (3-hop interference), which can reduce the intensity of interference having an influence on the relay.

Although the above description relates to the cases in which three or four relays are participating in the cooperative communication, it is applicable to a case in which more than four relays are participating in the cooperative communication. In other words, when N relays are participating in a cooperative communication, each sub-frame is divided into N resource zones and each relay frame has (N−2) silent zones from among N resource zones.

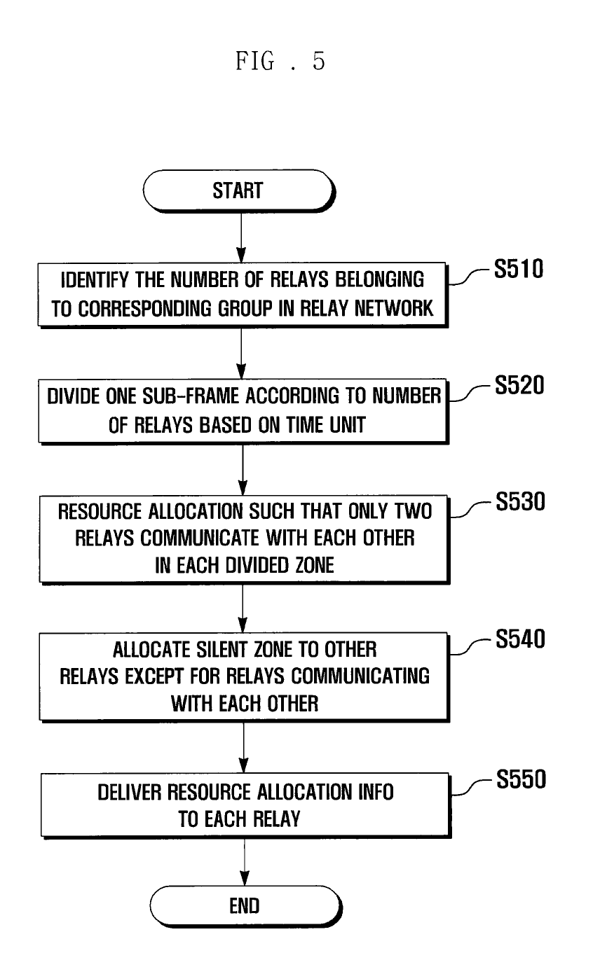

FIG. 5 is a flow diagram illustrating an operation process of a base station according to the first embodiment of the present invention.

The base station groups relays participating in a cooperative communication in a relay network and identifies the number of relays belonging to each group in step S510. In step S520, the base station divides a resource interval of one sub-frame in a time domain according to the number of relays.

The base station allocates resources for communication to only two relays in each divided zone in step S530, and allocates silent zones to the other relays except for the relays being in communication with each other in each divided zone in step S540. According to an embodiment of the present invention, in the same divided resource zone, the base station can allocate a resource for a lower relay of a relay having a resource, which has been allocated to a reception zone, to a silent zone. The base station delivers resource allocation information to each relay in step S550.

At the time of data transmission between relays, the transmitted data is delivered from a higher relay to a lower relay while multi-hopping the grouped relays. During the hopping, only two relays, to which resources for inter-communication are allocated, can communicate with each other.

### 2^{nd} Embodiment

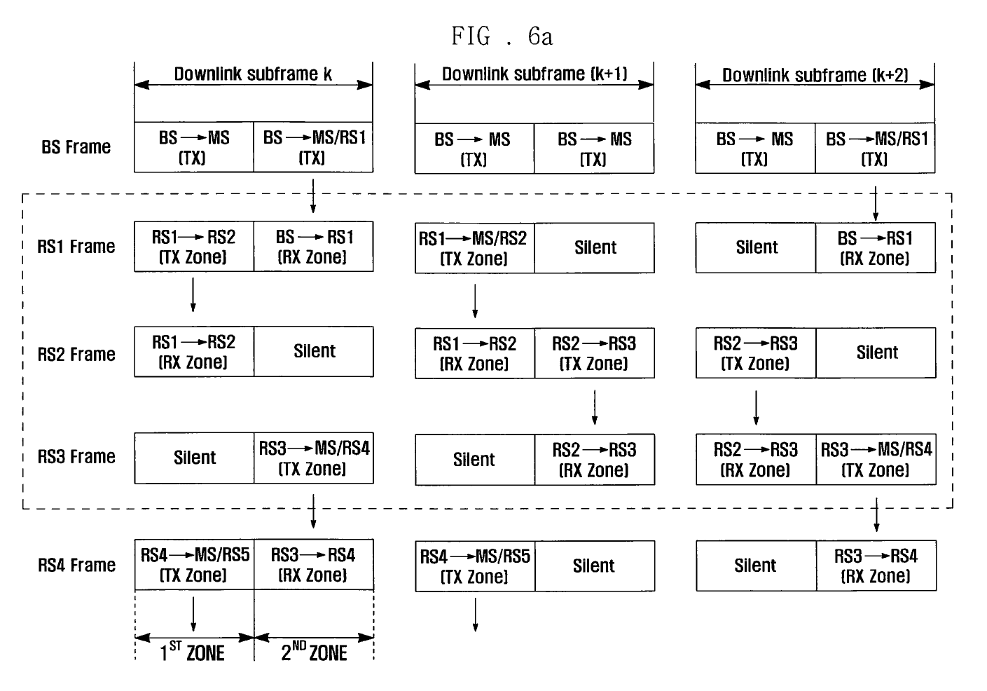

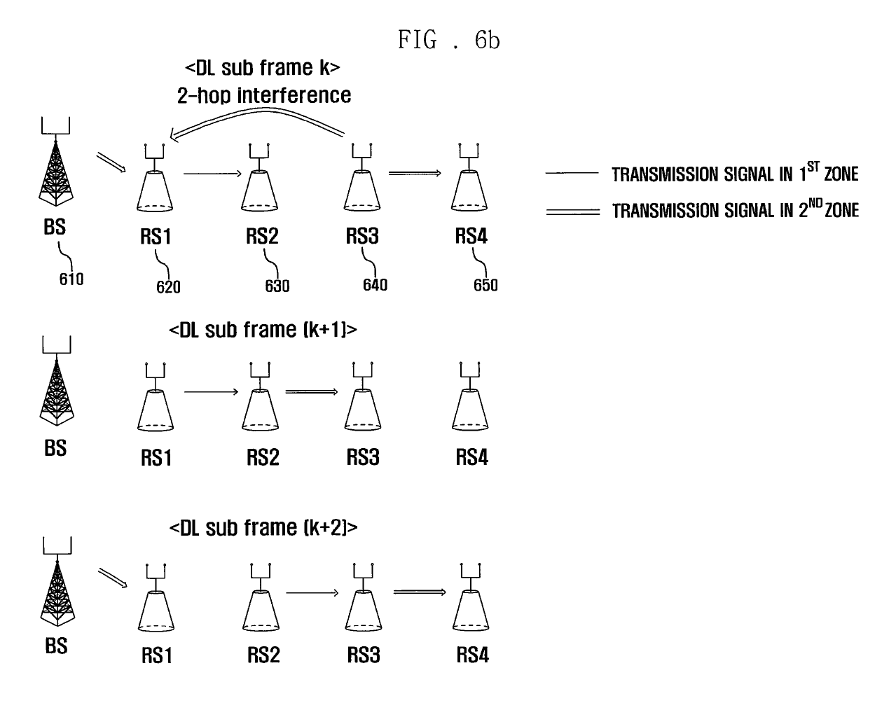

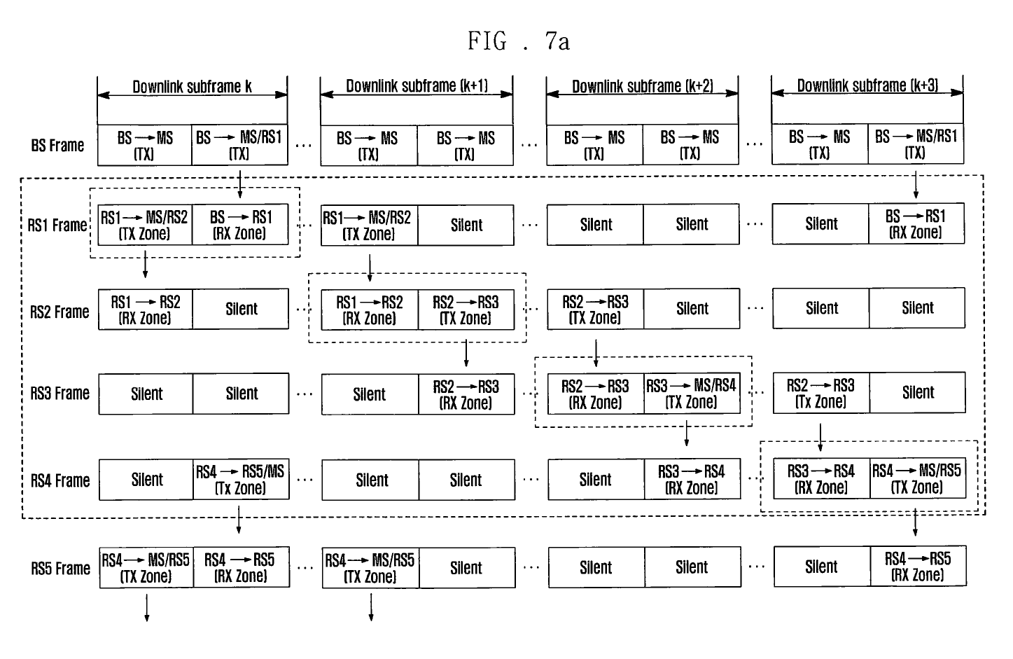

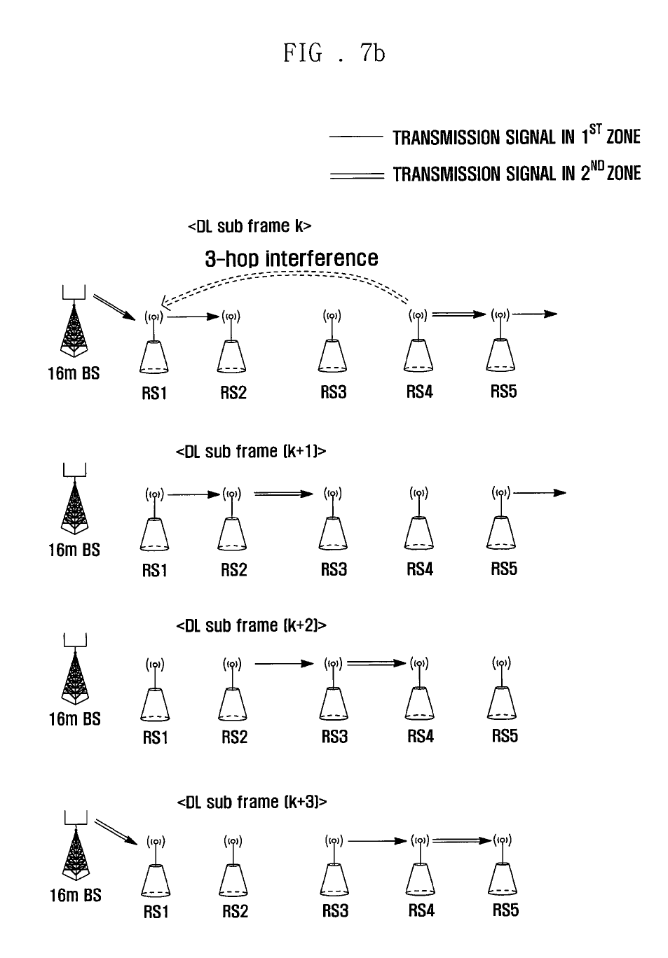

A multi-frame resource allocation method in which a base station groups sub-frames according to the number of relays participating in a cooperative communication will be described. FIGS. 6a and 6b correspond to a case in which three relays are participating in a cooperative communication, and FIGS. 7a and 7b correspond to a case in which four relays are participating in a cooperative communication.

FIG. 6a illustrates a multi-frame resource allocation method of downlink sub-frames when three relays are participating in a cooperative communication.

FIG. 6b illustrates the method of communication between nodes based on the resources allocated according to the method of FIG. 6a.

Referring to FIG. 6a, a base station identifies the number of relays participating in a cooperative communication, groups the sub-frames according to the number of relays, and then allocates resources to the grouped sub-frames.

Since three relays are participating in the cooperative communication in the structure shown in FIG. 6a, the base station groups the sub-frames three sub-frames by three sub-frames, for example, the base station makes a group including sub-frame k, sub-frame (k+1), and sub-frame (k+2).

The base station allocates resources for communication to only two relays in a divided resource zone of each sub-frame. In the first zone of sub-frame k, the base station allocates the first relay frame to a transmission zone and the second relay frame to a reception zone so that the first relay and the second relay can communicate with each other. The base station allocates the third relay frame to a silent zone, in order to prevent interference to the communication between the first relay and the second relay.

In the second zone of sub-frame k, the base station allocates the first relay frame to a reception zone and the third relay frame to a transmission zone so that the base station and the first relay can communicate with each other and the third relay and the fourth relay (or a mobile station) can communicate with each other. The base station allocates the second relay frame to a silent zone, in order to prevent interference to the communication as described above.

The principle described above can also be applied to sub-frame (k+1) and sub-frame (k+2). In the first zone of sub-frame (k+1), the base station allocates the first relay frame to a transmission zone and the second relay frame to a reception zone so that the first relay and the second relay can communicate with each other. The base station allocates the third relay frame to a silent zone, in order to prevent interference to the communication between the first relay and the second relay.

In the second zone of sub-frame (k+1), the base station allocates the second relay frame to a transmission zone and the third relay frame to a reception zone so that the second relay and the third relay can communicate with each other. The base station allocates the first relay frame to a silent zone, in order to prevent interference to the communication between the second relay and the third relay.

The principle described above can also be applied to sub-frame (k+2), as is apparent to one skilled in the art from the above description. Therefore, a more detailed description will be omitted here.

According to an embodiment of the present invention, in the same resource zone, the base station can allocate a resource for a lower relay of a relay having a resource, which has been allocated to a reception zone, to a silent zone. For example, in the second zone of sub-frame k, since the base station allocates the first relay frame to the reception zone, the base station can allocate the resource for the second relay, which is a lower relay of the first relay, to the silent zone. The same can be applied to the other zones.

As noted from FIG. 6a, when three relays are participating in a cooperative communication, one relay frame includes both a transmission zone and a reception zone, another relay frame includes a transmission zone and a silent zone, and the other relay frame includes a silent zone and a reception zone.

FIG. 6b illustrates the method of communication between nodes according to the resource allocation method described above. In each resource zone of each sub-frame, only two adjacent nodes communicate with each other. Therefore, it is possible to minimize the interference between the relays. In the case of sub-frame k shown in FIG. 6b, since the distance of interference becomes greater (2-hop interference), it is possible to reduce the intensity of interference having an influence on the relay.

First, FIG. 7a illustrates a multi-frame resource allocation method of downlink sub-frames when four relays are participating in a cooperative communication. FIG. 7b illustrates the method of communication between nodes based on the resources allocated according to the method of FIG. 7a.

Referring to FIG. 7a, since four relays are participating in the cooperative communication, the base station groups the sub-frames four sub-frames by four sub-frames, for example, the base station makes a sub-frame group including sub-frame k, sub-frame (k+1), sub-frame (k+2), and sub-frame (k+3).

The base station allocates resources for communication to only two relays in a divided resource zone of each sub-frame. In the first zone of sub-frame k, the base station allocates the first relay frame to a transmission zone and the second relay frame to a reception zone so that the first relay and the second relay can communicate with each other. The base station allocates the third relay frame and the fourth relay frame to silent zones, in order to prevent interference to the communication between the first relay and the second relay.

In the second zone of sub-frame k, the base station allocates the first relay frame to a reception zone and the fourth relay frame to a transmission zone so that the base station and the first relay can communicate with each other and the fourth relay and the fifth relay (or a mobile station) can communicate with each other. The base station allocates the second relay frame and the third relay frame to silent zones, in order to prevent interference to the communication as described above.

The principle described above can be applied to sub-frame (k+2) also, as is apparent to one skilled in the art from the above description. Therefore, a more detailed description will be omitted here.

According to an embodiment of the present invention, in the same resource zone, the base station can allocate a resource for a lower relay of a relay having a resource, which has been allocated to a reception zone, to a silent zone. For example, in the second zone of sub-frame k, since the base station allocates the first relay frame to the reception zone, the base station can allocate the resources for the second relay and the third relay, which are lower relays of the first relay, to the silent zones. The same can be applied to the other zones.

As noted from FIG. 7a, when four relays are participating in a cooperative communication, one relay frame includes both a transmission zone and a reception zone, another relay frame includes a transmission zone and a silent zone, another relay frame includes a silent zone and a reception zone, and the other relay frame includes two silent zones.

According to a multi frame resource allocation method, when N relays are participating in a cooperative communication, the relay frames include one relay frame having only a transmission zone, one relay frame having only a reception zone, and (N−3) relay frames having only silent zones.

FIG. 7b illustrates the method of communication between nodes according to the resource allocation method described above. In each resource zone of each sub-frame according to the present invention, only two adjacent nodes communicate with each other. Therefore, it is possible to minimize the interference between the relays. In the case of sub-frame k shown in FIG. 7b, since the distance of interference becomes greater (3-hop interference), it is possible to reduce the intensity of interference having an influence on the relay. Further, the occurrence of 3-hop interference as described above is also found in sub-frame (k+1) to sub-frame (k+3).

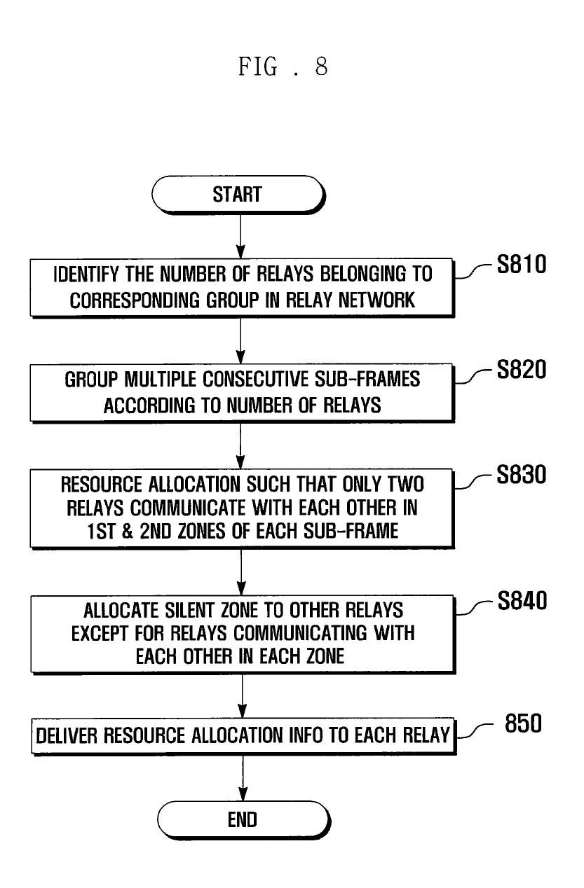

FIG. 8 is a flow diagram illustrating an operation process of a base station according to the second embodiment of the present invention. First, the base station groups relays participating in a cooperative communication in a relay network and identifies the number of relays belonging to each group in step S810. In step S820, the base station groups consecutive sub-frames corresponding to the number of relays. For example, when three relays are grouped into one group, sub-frame k, sub-frame (k+1), and sub-frame (k+2) are bundled into one sub-frame group.

The base station allocates resources for communication to only two relays in the first zone and the second zone of each sub-frame in step S830, and allocates silent zones to the other relays except for the relays being in communication with each other in step S840. According to an embodiment of the present invention, in the same divided resource zone, the base station can allocate a resource for a lower relay of a relay having a resource, which has been allocated to a reception zone, to a silent zone. The base station delivers resource allocation information to each relay in step S850.

At the time of data transmission between relays, the transmitted data is delivered from a higher relay to a lower relay while multi-hopping the grouped relays. During the hopping, only two relays, to which resources for inter-communication are allocated, can communicate with each other.

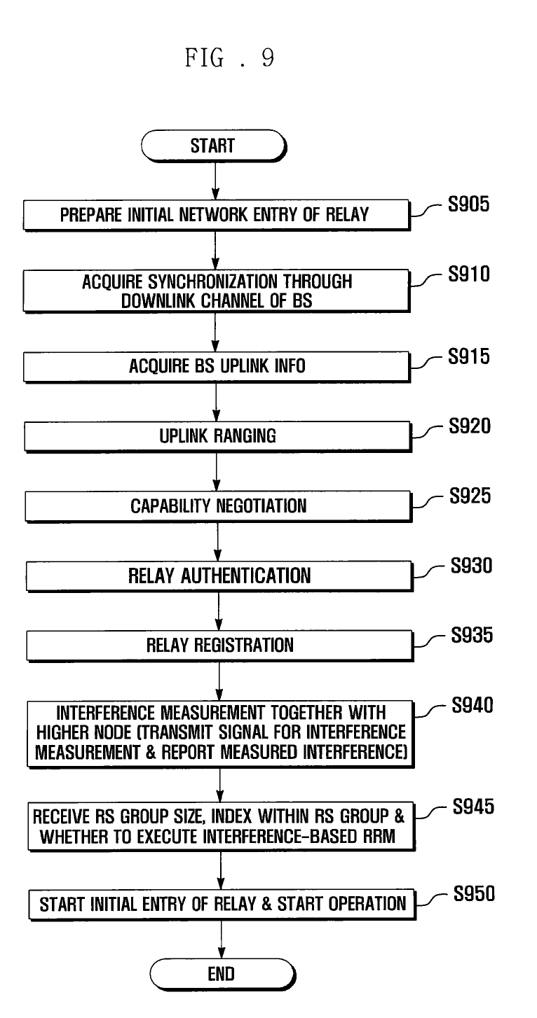

FIG. 9 is a flow diagram illustrating a process of initial network entry of a relay for a radio resource management operation according to an embodiment of the present invention. The process shown in FIG. 9 can be commonly applied to the first embodiment and the second embodiment of the present invention.

In order to apply a radio resource management method proposed by the present invention in a relay group including K relays, it is necessary to know the index of each relay of the relay group participating in the cooperative communication, that is, it is necessary to know at which hop each relay is located. Each relay should determine whether to apply the radio resource management method using a silent zone. To this end, the present invention enables related signaling and configuration at the time of initial network entry.

According to the present invention, the determination of whether to apply the radio resource management method using a silent zone is based on measurement of interference between adjacent relays. When a relay initially accesses a network and performs a network entry process through a higher node, the relay performs a process of measuring interference from the higher node and a process of transmitting a signal for measuring the interference in the higher node.

In order to measure interference from the higher node, a lower node measures the intensity of a preamble or a pilot signal of the higher node in the downlink, and reports a value obtained through the measurement to the higher node. The lower node transmits a signal for measuring the interference at the higher node in the uplink, and the higher node receiving the uplink signal measures the intensity of the uplink signal.

The higher node determines whether to apply the radio resource management method of the present invention, based on the quantity of interference to the uplink signal measured by the higher node itself and the quantity of downlink interference measured and reported by the lower node.

In addition, the higher node transmits a result of the determination to a lower node having newly accessed the network. The information transmitted from the higher node to the lower node having newly accessed the network includes a size (K) of the relay group, an index of a corresponding index within the relay group, and information on whether to execute an operation of the radio resource management method according to the present invention.

A lower node having received the information from the higher node sets an operation proper for the information and then terminates the network entry process. Such a network entry process as described above is illustrated in FIG. 9.

A relay (lower node) prepares an initial network entry process of a relay in step S905. The relay acquires a synchronization through a downlink channel of a base station in step S910, and acquires uplink information of the base station in step S915. The relay performs an uplink ranging in step S920 and performs a capability negotiation in step S925.

The relay performs a relay authentication process for the base station in step S930, and performs a relay registration process in step S935.

The relay performs interference measurement, together with the higher node in step S940. As described above, the relay measures the intensity of a preamble or a pilot signal of the higher node in the downlink, and reports a value obtained through the measurement to the higher node. Simultaneously, the lower node transmits a signal for measuring the interference to the higher node in the uplink. The higher node determines whether to apply the radio resource management method of the present invention, based on the quantity of interference to the uplink signal measured by the higher node itself and the quantity of downlink interference measured and reported by the lower node.

Then, in step S945, the relay receives information necessary for execution of a radio resource management method of the present invention, which includes a size (K) of the relay group, an index of a corresponding index within the relay group, and information on whether to execute an operation of the radio resource management method according to the present invention, from the higher node. In step S950, the relay initiates the initial network entry process.

The silent zone is defined as a zone in which a signal is not transmitted. According to another embodiment of the present invention, it is possible to employ a modification in which the silent zone is reused with a low power. That is, in the silent zone, it is possible to transmit a signal to a user located adjacent to the relay with a relatively low power in comparison with a resource zone in which a service is provided with a regular power. An operation of the silent zone in such a way as described above can be employed according to the policy of a network operator. Further, when a low power level corresponding to the silent zone is set to 0, the silent zone can be set as a resource zone in which there is no transmission.

According to the present invention, in a relay network including multiple relays participating in a cooperative communication, a base station allocates resources after dividing one sub-frame resource interval in a time domain according to the number of relays or grouping multiple sub-frames according to the number of relays. Therefore, in the relay network according to the present invention, since only two relays communicate with each other in a particular time zone, it is possible to prevent interference between the relays.

Although embodiments of the present invention have been described in detail hereinabove, it should be clearly understood that many variations and modifications of the basic inventive concepts herein described, which may be apparent to those skilled in the art, will still fall within the spirit and scope of the exemplary embodiments of the present invention as defined in the appended claims.

What is claimed is:

1. A method of resource allocation by a base station in a multi hop relay network, the method comprising the steps of:
identifying a number of relays participating in a cooperative communication;
dividing in a time domain a sub-frame resource interval of the relay according to the identified number of relays; and
allocating resources so that only two relays can communicate with each other in a divided resource zone, and transmitting data while performing multi-hopping between the relays,
wherein only two of the relays communicate with each other within any one sub-frame during the multi-hopping.

2. The method of claim 1, wherein, in allocating the resources, resource zones of other relays except for the two relays communicating with each other are allocated to silent zones in which signals are not transmitted.

3. The method of claim 2, wherein, in allocating the resources, a resource zone for a lower relay of a relay, the divided resource zone which is allocated to a reception zone, is allocated to a silent zone.

4. The method of claim 1, wherein at least three relays are participating in the cooperative communication.

5. A method of resource allocation by a base station in a multi hop relay network transmitting and receiving a sub-frame including a first zone and a second zone, the method comprising the steps:
identifying a number of relays participating in a cooperative communication;
grouping multiple consecutive sub-frames according to the identified number of relays; and
allocating resources so that only two relays can communicate with each other in the first zone and the second zone of the grouped multiple sub-frames, and transmitting data while performing multi-hopping between the relays,
wherein only two of the relays communicate with each other within any one sub-frame during the multi-hopping.

6. The method of claim 5, wherein, in allocating the resources, resource zones of other relays except for the two relays communicating with each other are allocated to silent zones in which signals are not transmitted, in the first zone and the second zone of the grouped multiple sub-frames.

7. The method of claim 6, wherein, in allocating the resources, a resource zone for a lower relay of a relay, a resource zone of which is allocated to a reception zone, is allocated to a silent zone.

8. The method of claim 5, wherein at least three relays are participating in the cooperative communication.

9. An apparatus for resource allocation in a multi hop relay network, the apparatus comprising:
a relay grouping unit for identifying a number of relays participating in a cooperative communication and grouping the relays; and
a resource allocation unit for dividing in a time domain a sub-frame resource interval of the relay according to the number of grouped relays and allocating resources so that only two relays can communicate with each other in a divided resource zone.

10. The apparatus of claim 9, wherein, in allocating the resources, resource zones of other relays except for the two relays communicating with each other in the divided resource zone are allocated to silent zones in which signals are not transmitted.

11. The apparatus of claim 10, wherein, in allocating the resources, a resource zone for a lower relay of a relay, the divided resource zone of which is allocated to a reception zone, is allocated to a silent zone.

12. An apparatus for resource allocation in a multi hop relay network transmitting and receiving a sub-frame including a first zone and a second zone, the apparatus comprising:
a relay grouping unit for identifying a number of relays participating in a cooperative communication and grouping the relays; and
a resource allocation unit for grouping multiple consecutive sub-frames according to the identified number of relays and allocating resources so that only two relays can communicate with each other in the first zone and the second zone of the grouped multiple sub-frames.

13. The apparatus of claim 12, wherein, in allocating the resources, resource zones of other relays except for the two relays communicating with each other are allocated to silent zones in which signals are not transmitted, in the first zone and the second zone of the grouped multiple sub-frames.

14. The apparatus of claim 13, wherein, in allocating the resources, a resource zone for a lower relay of a relay, a resource zone of which is allocated to a reception zone, is allocated to a silent zone.
